(19) United States
(12) Patent Application Publication
(10) Pub. No.: US 2024/0373870 A1
(43) Pub. Date: Nov. 14, 2024

(54) GEL COMPOSITIONS WITH HIGH THERMAL STABILITY AND METHODS OF MAKING THE SAME

(71) Applicant: Minutri Inc., Mountain View, CA (US)

(72) Inventors: Michelle C Lee, Mountain View, CA (US); Jen-Yu Huang, Mountain View, CA (US)

(21) Appl. No.: 18/577,275

(22) PCT Filed: Jul. 8, 2022
(86) PCT No.: PCT/US22/73580

§ 371 Date: Jan. 8, 2024

Related U.S. Application Data
(60) Provisional application No. 63/219,493, filed on Jul. 8, 2021.

(51) Int. Cl. A23D 7/005; A23D 7/04; C08J 3/075; C08L 91/00

(52) U.S. Cl. CPC A23D 7/0053; A23D 7/04; C08J 3/075; C08L 91/00; C08J 2391/00; C08J 2489/00; C08J 2491/00

(57) ABSTRACT

A gel composition includes an oleogel dispersed within an aqueous gel which is continuous phase. the oleogel comprising either a plant-based oil in liquid state at room temperature and a wax, or a plant-based oil in non-liquid state at room temperature. and the aqueous gel comprising water and at least one of protein and polysaccharide. The present disclosure also discloses an edible composition comprising the gel composition, and the use of this edible composition as an animal fat substitute. The present disclosure further discloses a food product comprising the edible composition. Methods for making the gel composition are also disclosed.

### RELATED APPLICATION

This application claims priority to U.S. Provisional Patent Application Ser. No. 63/219,493, filed on Jul. 8, 2021, entitled “High-heat Stable Solid Fat Replacer for Food Applications,” which is incorporated herein by reference in its entirety for all purposes.

### BACKGROUND OF THE INVENTION

### Field of the Invention

The present disclosure relates to a gel composition, a method for manufacturing a gel composition, and a product containing the gel composition, especially to an edible gel composition and food product with high plant-based oil content and high thermal stability.

### Description of Related Art

The demand for plant-based meat is growing due to sustainability concerns, health issues, religious restrictions, and many other reasons. Despite quickly increasing sales, plant-based meat needs to be more like animal meat to fulfill the market needs, and the key ingredient is the fat composition providing the taste, texture, and appearance of plant-based meat. Since vegan oils have different melting points, textures, and more flavor volatility than animal fats, the manufacturing of plant-based meat usually adds excessive solid vegan oils (e.g. coconut oils and palm oils) to create a similar mouthfeel to animal meat. However, such strategies will inevitably increase the digested amount of saturated fats and result in health problems. To achieve a more animal meat-like mouthfeel and to reduce the usage of solid vegan oils, the plant-based fats need to have animal fat-like textures, animal meat-like mouthfeel, high oil delivery efficiency, and high thermal stability withstanding high cooking temperature.

It is common in the food industry to convert liquid oil into solid fat such as spreads and margarine. Hydrogenation is one of the processes to solidify liquid oil but requires catalysts and sophisticated chemical reactions. Moreover, during the hydrogenation, it usually results in the production of trans-fat, which adversely affects human health. Another process is to add structuring agents to the oil to generate a solid texture. There are also some structuring agents in the food industry to provide solid fats, However, they cannot provide the desired animal fat-like textures, animal meat-like mouthfeel, high oil delivery efficiency, and high thermal stability withstanding high cooking temperature.

### SUMMARY

Concerning the issues mentioned above, a gel composition is provided in this disclosure to give animal fat-like textures, high oil delivery efficiency, and high thermal stability withstanding high cooking temperature.

Accordingly, the gel composition of the present disclosure includes an oleogel and an aqueous gel. The oleogel is dispersed within the aqueous gel which is continuous phase to form the gel composition. The oleogel comprises either a plant-based oil in liquid state at room temperature and a wax, or a plant-based oil in non-liquid state at room temperature. The aqueous gel comprises water and at least one of protein and polysaccharide.

Additionally, the gel composition provides texture (with certain hardness), high plant-based oil content (at least 50 weight percent plant-based oil of the gel composition), and high thermal stability (high melting point).

Accordingly, an edible composition containing the gel composition of the present disclosure is disclosed. The edible composition may further comprises a flavorant. In addition, the edible composition may be incorporated in food product as fat substitute which has animal fat-like texture and animal meat-like mouthfeel.

Accordingly, the method of manufacturing a gel composition comprises providing an oleogel at a temperature above approximately 70° C., wherein the oleogel comprises a plant-based oil in non-liquid state at room temperature or is prepared by mixing a plant-based oil in liquid state at room temperature and a wax, providing an aqueous gel at a first stage cross-linking condition by mixing water and at least one of protein and polysaccharide, and forming the gel composition by dispersing the oleogel in the aqueous gel which is continuous phase.

Additionally, the method of manufacturing a gel composition, where the aqueous gel in the gel composition is at a second stage cross-linking condition which is stronger than the first stage cross-linking condition. The second stage cross-linking condition is produced by adding enzyme or ionic compound to the gel composition.

Accordingly, the method of manufacturing a food product comprising a step of incorporating the gel composition into the food product is disclosed.

Other aspects and advantages of the disclosure will become apparent from the following detailed description, taken in conjunction with the accompanying drawings.

### BRIEF DESCRIPTION OF THE DRAWINGS

FIG. 1 is a photograph of the gel composition in accordance with one embodiment of the present disclosure.

FIG. 2 is a microscopy image of the gel composition showing the emulsion property in accordance with one embodiment of the present disclosure.

FIG. 3 is a schematic diagram illustrating the hardness of the gel composition in accordance with one embodiment of the present disclosure.

FIG. 4A, 4B, 4C, and 4D are photographs of the food products containing the gel composition in accordance with one embodiment of the present disclosure.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below;

however, any terminology intended to be interpreted in any restricted manner will be specifically defined as such in this Detailed Description section. The term “melting point” used in the present disclosure refers to the temperature when the liquid begins to gradually come out from the gel composition (liquid leaking temperature).

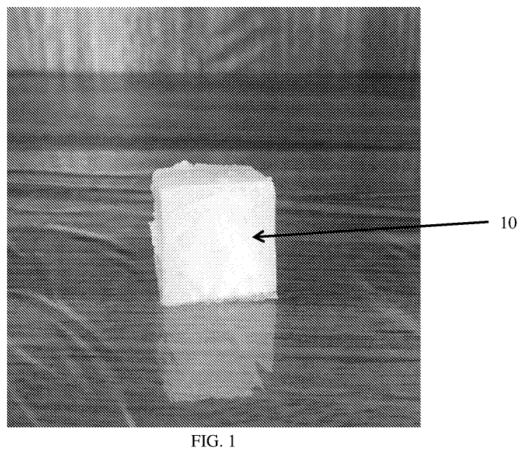

The present disclosure relates to a gel composition comprising an oleogel dispersed within an aqueous gel which is continuous phase. The oleogel comprises either a plant-based oil in liquid state at room temperature and a wax, or a plant-based oil in non-liquid state at room temperature. And the aqueous gel comprises water and at least one of protein and polysaccharide. In one embodiment, the plant-based oil is approximately 50-85 weight percent of the gel composition, and the aqueous gel is approximately 15-50 weight percent of the gel composition. The photograph of the gel composition 10 in accordance with one embodiment of the present disclosure is shown in FIG. 1.

The plant-based oil in liquid state at room temperature of the gel composition may include one or more plant-based oils, including but not limited to canola oil, sunflower oil, grapeseed oil, avocado oil, palm oil, olive oil, vegetable oil, algal oil, corn oil, high oleic oil, almond oil, cottonseed oil, Macadamia oil, peanut oil, soybean oil, walnut oil, sesame oil, safflower oil, flaxseed oil, rapeseed oil, rice bran oil, hemp oil, castor oil, and pecan oil. The plant-based oil in non-liquid state at room temperature may include one or more plant-based oils, including but not limit to coconut oil, palm oil, and cocoa butter. The palm oil may be in liquid state (such as olein, super olein, soft PMF, mid olein) or non-liquid state (palm mid fraction, hard stearin, super PMF), depending on the origin and the content of the palm oil. The oleogel does not comprise hydrogenated oils.

The wax, mixed in the plant-based oils, may provide structure, texture, hardness, and integrity to create the oleogel or gelled oil phase. More specifically, the wax mixed in the plant-based oils may include one or more waxes, including but not limited to bee's wax, candelilla wax, Carnuba wax, rice bran wax, paraffin wax, sugarcane wax, sunflower wax, jojoba wax, ouricury wax, Myrica fruit wax, berry wax, microcrystalline wax, Japan wax, and retamo wax. In one embodiment, the wax is approximately 0.1-5 weight percent of the oleogel. The aqueous gel of the gel composition may include at least one of protein and polysaccharide which provides structure, texture, hardness, and integrity to create the aqueous gel or gelled aqueous phase. The protein of the gel composition may include one or more proteins, including but not limited to soy protein isolate, pea protein isolate, soy protein concentrate, gluten flour, wheat protein, potato protein, pea protein concentrate, whey protein isolate/concentrate, fava bean protein, chickpea protein, lentil protein, gelatin, collagen. In one embodiment, the protein is approximately 0.01-20 weight percent of the aqueous gel. The protein in the aqueous gel may be cross-linked. The pH of the aqueous gel may be approximately between 3 to 8. The polysaccharide of the gel composition may include one or more polysaccharides, including but not limited to carrageenan, chondroitin sulfate, gum Arabic, guar gum, konjac gum, pectin, plant fibers, alginate, agar, gellan gum, locust bean gum, xanthan gum, curdlan gum, methylcellulose, tara gum, carboxymethyl cellulose, bacteria cellulose. The polysaccharide in the aqueous gel may be cross-linked.

The animal fat-like texture may be presented by the hardness of the gel composition, which ranges approximately from 30 to 250 gf (gram-force) measured by Texture Profile Analysis using a trigger force of 1 g, a target distance of 3 mm, and a test speed of 2 mm/s. In addition, the gel composition may have a melting point above approximately 80° C., preferably above approximately 180° C.

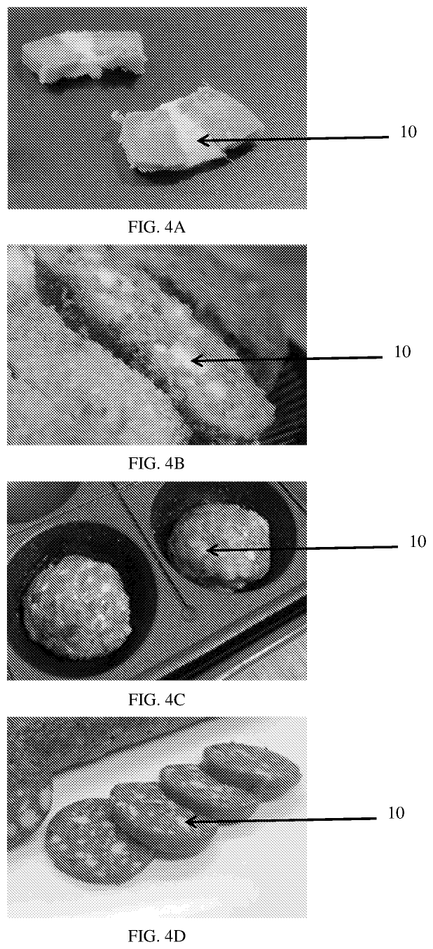

In one embodiment, an edible composition comprises a gel composition described above. In one aspect, the edible composition is an animal fat substitute. In another aspect, the edible composition may include one or more flavorants, including but not limited to meat flavors, beef fat flavors, tallow flavors, lard flavors, yeast extract, pork flavors, chicken flavors, bacon flavors, beef flavors, fish flavors, egg flavor, garlic flavors, butter flavors, savory flavors, onion flavors, herbal flavors, and smoky flavors. In another aspect, the fat substitute may include one or more of a variety of substitutes, including but not limited to a fat substitute, butter substitute, animal fat substitute, hydrogenated oil substitute, saturated fat substitute, baking oil substitute, beef-fat substitute, a pork-fat substitute, a bacon-fat substitute, or a pork-belly-fat substitute. In another embodiment, a food product comprises the edible composition. The food product may include one or more of a variety of products, including but not limited to a vegan product, a vegetarian product, an animal-free product, an alternative-meat product, a plant-based product, or a free of animal-derived product. The food product incorporating such edible composition may include one or more of a variety of products, including but not limited to an alternative-meat burger, alternative-meat bacon, alternative-meat beef, alternative-meat patty, alternative-meat dumpling, alternative-meat pork belly, alternative-meat meatball, alternative ground beef, alternative ground pork, alternative ground turkey, alternative ground chicken, alternative-meat seafood, alternative salmon, alternative shrimp, alternative-meat steak, alternative porkchop, alternative chicken, alternative chicken drumstick, alternative chicken thigh, alternative lamb, alternative duck, alternative pork, alternative sausage, alternative cheese, alternative salami, and alternative egg. The photograph of the plant-based food products containing the gel composition 10 is shown in FIG. 4A (plant-based bacon), 4B (plant-based fried burger patties), 4C (plant-based meatball), and 4D (plant-based pepperoni).

A method for preparing the gel composition is also provided. The method comprises providing an oleogel at a temperature above approximately 70°° C., wherein the oleogel comprises a plant-based oil in non-liquid state at room temperature or is prepared by mixing a plant-based oil in liquid state at room temperature and a wax, providing an aqueous gel at a first stage cross-linking condition by mixing water and at least one of protein and polysaccharide, and forming the gel composition by dispersing the oleogel in the aqueous gel which is continuous phase.

The gel composition may be considered as stable when one or more of the following circumstances are observed. The melting point and/or hardness of the gel composition lies within the range provided. The viscosity and the texture of the mixtures do not change significantly during the manufacturing process and certain period of time after being manufactured. The gel composition has solid texture measured by Texture Profile Analysis or can simply cut by knife into a certain shape. There are no oil droplets on the surface of the gel composition. The texture of the gel composition does not observably change after storage for certain period of time, such as several days. The microscopic image of the gel composition demonstrates that oleogel is well dispersed in the aqueous gel which is continuous phase (oil-in-water emulsion, rather than water-in-oil emulsion).

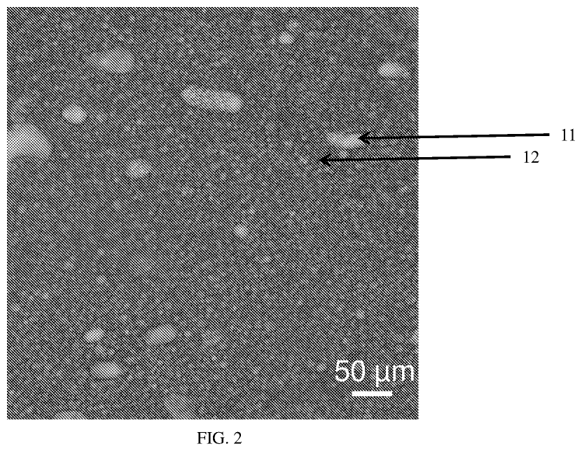

The first stage cross-linking condition of the aqueous gel may be produced by applying heat to above approximately 70° C., applying high-intensity sonication, adding enzyme, or changing a pH of the aqueous gel. In one embodiment, the aqueous gel in the gel composition is at a second stage cross-linking condition which is stronger than the first stage cross-linking condition. The second stage cross-linking condition may be produced by adding enzyme or ionic compound to the gel composition. The microscopic image of the gel composition as shown in FIG. 2 illustrates the emulsion property that the oleogel 11 (light color) is dispersed within the aqueous gel 12 which is continuous phase (dark color). In one embodiment, the plant-based oil is approximately 50-85 weight percent of the gel composition, and the aqueous gel is approximately 15-50 weight percent of the gel composition.

In general, cross-linking may occur between proteins, polysaccharides, and also between proteins and polysaccharides. Cross-linking of proteins may be induced by applying heat to above 70° C., using high-intensity sonication, the addition of an enzyme, or changing the pH. Cross-linking of polysaccharides may be induced by applying heat to above 70° C., using high-intensity sonication, the addition of ionic compounds, changing the pH, or by the presence of a mixture of polysaccharides. Cross-linking between protein and polysaccharide may be induced by applying heat to above 70° C., using high-intensity sonication, the addition of ionic compounds, or changing the pH.

The cross-linking can increase the gel strength of the aqueous gel and therefore increase the hardness and particularly the melting point of the formed gel composition. The advantages and disadvantages of different cross-linking methods may be considered. Changing the pH is an easy method to induce cross-linking, but it will contribute acid or basic flavors of the food product, and the shelf-life is also affected. Addition of ionic compounds may decrease the stability of the product depending on the polysaccharide and proteins used in the process. Addition of enzymes may provide strong cross-linking. However, enzymes only work under certain temperatures, and the cross-linking requires a period of time to occur. High-intensity sonication also requires a longer period of time for cross-linking to occur. Moreover, sonication may generate heat and accelerate the oxidation, therefore reducing the quality of products. The effect of cross-linking conditions on the solidity (hardness) and melting point of the gel composition in accordance with one embodiment of the present disclosure is provided in Example 5.

In addition, a method for manufacturing a food product may comprise the step of incorporating gel composition or edible composition as described above into a food product by any appropriate method available to those skilled in the art. For example, the gel composition or edible composition of the present disclosure may be marbled into alternative meat.

Below are some embodiments of the gel composition. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present disclosure covers modifications and variations that come within the scope of the appended claims and their equivalents.

### EXAMPLES

### Example 1

The gel composition of the disclosure contains plant protein, one or more structurant, one or more additives, one or more plant-based oils, and water. One such gel composition was prepared as follows. The proportion of the ingredients is listed in Table 1 below:

TABLE 1

| Ingredient | % of total product weight |
|---|---|
| Plant protein | 1 |
| Structurant (wax) | 0.5 |
| Oil (canola oil) | 68 |
| Water | 30 |
| Additives (calcium chloride) | 0.5 |

All kinds of plant proteins may be used, for example, pea protein isolate, soy protein concentrate, gluten flour, wheat protein, potato protein, pea protein concentrate, whey protein isolate/concentrate, fava bean protein, chickpea protein, lentil protein, gelatin, and collagen. The plant protein was dissolved in water. This example uses soy protein isolate solution, which was heated to 90° C. for 10 minutes to provide an aqueous gel at a first stage cross-linking condition. The structurant of the oleogel in this example was prepared by adding 0.5 weight percent bee's wax. Other structurants may be used, for example, candelilla wax, Carnuba wax, rice bran wax, paraffin wax, sugarcane wax, sunflower wax, jojoba wax, ouricury wax, and retamo wax. 68 weight percent canola oil was used in this example. Other oils that can be used include coconut oil, sunflower oil, grapeseed oil, avocado oil, palm oil, olive oil, vegetable oil, algal oil, corn oil, almond oil, cocoa butter, cottonseed oil, Macadamia oil, peanut oil, soybean oil, walnut oil, sesame oil, safflower oil, flaxseed oil, rapeseed oil, rice bran oil, hemp oil, castor oil, and pecan oil. The wax-oil mixture (oleogel) was heated to 90° C. The oil mixture (oleogel) was slowly added to the water mixture (aqueous gel) under constant stirring at 6000 rpm with a homogenizer. The emulsion was formed when the entire oil mixture was dispersed into the water mixture. The gel composition was cooled until it reached 25° C. 0.5 weight percent calcium chloride was further mixed into the gel composition, which results in the aqueous gel in the gel composition having a second stage cross-linking condition which is stronger than the first stage cross-linking condition. The calcium chloride-added gel composition was stored at 25° C. overnight.

### Example 2

Various recipes were prepared to examine the effect of pH on the stability of the gel composition. The preparation of the gel composition of disclosure followed the same method as previously described in Example 1 with the following modifications.

1 weight percent soy protein was suspended in water. The soy protein water solution's pH was then adjusted to the desired range with citric acid, and the pH was measured by pH meter. The pH-adjusted solution was then heated to 90° C. for 10 minutes. The subsequent steps of preparation followed the same method as stated in Example 1.

When the gel composition was prepared with a soy protein solution having a pH less than 3, an unstable gel composition was formed. The gel composition experienced phase separation and resulted in a liquid form. If phases are separated, the product would have high fluidity and result in two separate phases over time, visually observable.

When the gel composition was also prepared with a soy protein solution with a pH greater than 3, a stable gel composition was formed. The resulting gel composition had a desirable solid texture. Form assessments were performed by using a knife. If it can be cut into certain shapes, it is referred to as a desirable solid texture. This example illustrates that the pH of the aqueous gel has an impact on the properties of the gel composition.

### Example 3

The effect of structurant and plant-based oil on the solidity and melting point of the gel composition was assessed. The preparation of the gel composition of disclosure followed the same method as previously described in Example 1 with the following modifications.

The varying oil mixtures (oleogel) were prepared by adding corresponding weight percent bee's wax to 67 weight percent corresponding plant-based oil and the mixture was heated to 90° C.

The hardness of the gel composition is measured by Texture Profile Analysis using a trigger force of 1 g, a target distance of 3 mm, and a test speed of 2 mm/s. The melting point is recorded by heating the gel composition; the temperature when the liquid begins to gradually come out from the gel composition (liquid leaking temperature) is recorded using an infrared thermometer.

When the type of oil used was canola oil (liquid oil) without adding bee's wax, the gel composition was very soft with hardness less than 50-60 gf, and with a melting point around 180-200° C.

When the type of oil used was coconut oil (solid oil) without adding bee's wax, the gel composition was elastic solid with hardness of 100-120 gf at room temperature, and a melting point around 95-200° C.

When the type of oil used was liquid plant oil (e.g. canola oil and corn oil) with around 1 weight percent bee's wax of the gel composition, the gel composition was firm with hardness of 120-130 gf at room temperature and a melting point up to 180-250° C.

When the type of oil used was solid plant oil (e.g. coconut oil and palm oil) with around 0.5 weight percent bee's wax of the gel composition, the gel composition had a higher firm texture with hardness of 120-130 gf at room temperature and melting point (200-260° C.).

This example illustrates that adding wax provides structure, texture, hardness, and integrity to the gel composition, with increasing melting point regardless of the type of oil used.

### Example 4

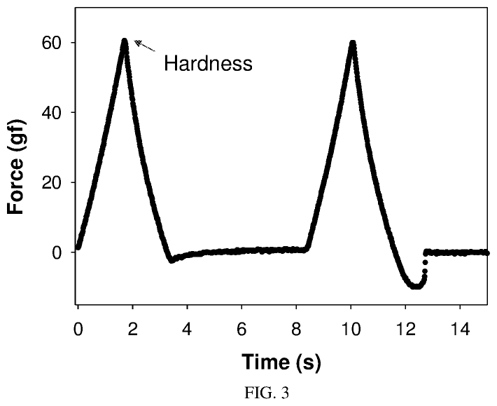

The effect of bee's wax concentration on the hardness and melting point of the gel composition was assessed. The preparation of the gel composition of disclosure followed the same method as previously described in Example 1 with the following modifications. The hardness of the gel composition is measured by Texture Profile Analysis using a trigger force of 1 g, a target distance of 3 mm, and a test speed of 2 mm/s. The hardness of the gel composition that can be used as an animal fat substitute with a melting point around 200° C. was measured as the hardness metrics shown in FIG. 3.

When the bee's wax was added at 0 weight percent of the oleogel (it is not an oleogel, this is only a comparative example), the gel composition was solid with a melting point around 180-200° C. The hardness of the gel composition was measured by Texture Profile Analysis having a reading of 57.0+3.0 gf.

When the bee's wax was added at 0.1 weight percent of the oleogel, the gel composition was solid with a melting point around 180-200° C. The hardness of the gel composition was measured by Texture Profile Analysis having a reading of 61.5+1.7 gf. It was firmer than the gel composition made with no bee's wax.

When the bee's wax was added at 0.5 weight percent of the oleogel, the gel composition was solid with a melting point around 180-210° C. The hardness of the gel composition was measured by Texture Profile Analysis having a reading of 62.6+2.9 gf. The texture was similar to the gel composition made with 0.1% bee's wax.

When the bee's wax was added at 1 weight percent of the oleogel, the gel composition was solid with a melting point around 220-250° C. The hardness of the gel composition was measured by Texture Profile Analysis having a reading of 88.3+3.5 gf. It was firmer than the gel composition made with 0.5 weight percent of bee's wax.

When the bee's wax was added at 3 weight percent of the oleogel, the gel composition was solid with a melting point around 230-250° C. The hardness of the gel composition was measured by Texture Profile Analysis having a reading of 124.4±4.3 gf. It was slightly firmer than the gel composition made with 1 weight percent of bee's wax.

When the bee's wax was added at 5 weight percent of the oleogel, the gel composition was solid with a melting point around 250-260° C. The hardness of the gel composition was measured by Texture Profile Analysis having a reading of 203.8±4.5 gf. It was firmer than the gel compositions made with 3 weight percent of bee's wax.

The results are summarized in Table 2:

TABLE 2

| Wax (weight percent | Melting | Hardness | |
|---|---|---|---|
| of the oleogel) | Point (° C.) | (gf) | Solidity |
| 0 | 180-200 | 57.0 ± 3.0 | Solid |
| 0.1 | 180-200 | 61.5 ± 1.7 | Solid |
| 0.5 | 180-210 | 62.6 ± 2.9 | Solid |
| 1 | 220-250 | 88.3 ± 3.5 | Solid |
| 3 | 230-250 | 124.4 ± 4.3 | Solid |
| | | | Slightly firmer |
| | | | than 1% |
| 5 | 250-260 | 203.8 ± 4.5 | Solid |
| | | | Firmer than 3% |

This example illustrates that the wax concentration has an impact on the properties of the gel composition.

### Example 5

The effect of cross-linking conditions on the solidity and melting behavior of the gel composition was assessed. The preparation of the gel composition of disclosure followed the same method as previously described in Example 1 with the following modifications.

The gel composition of this example contains one or more polysaccharides, one or more plant proteins, one or more structurants, one or more additives, one or more oils, and water. One such gel composition was prepared as follows. The proportion of the ingredients is listed in Table 3 below:

TABLE 3

| Ingredient | % of total product weight |
|---|---|
| Polysaccharide | 0.5 |
| Plant protein | 1 |
| Structurant (wax) | 0.5 |
| Oil (canola oil) | 68 |
| Water | 30 |
| Additives (calcium chloride) | 0.5 |

Different kinds of polysaccharides can be used, for example, carrageenan, chondroitin sulfate, gum Arabic, guar gum, konjac gum, pectin, plant fibers, alginate, agar, gellan gum, locust bean gum, xanthan gum, curdlan gum, methylcellulose, tara gum, carboxymethyl cellulose, bacteria cellulose. Different kinds of plant proteins can be used, for example, pea protein isolate, soy protein concentrate, gluten flour, wheat protein, potato protein, pea protein concentrate, whey protein isolate/concentrate, fava bean protein, chickpea protein, lentil protein, gelatin, and collagen.

The polysaccharide and plant protein was dissolved in water. This example uses gum carrageenan for polysaccharide and soy protein isolate for protein to prepare the aqueous solution, which was heated to 90° C. for 10 minutes.

When there is no wax in the oil phase and the aqueous gel is at a first stage cross-linking condition, the resulting gel composition melts like coconut oil but has a higher melting point about 100-110° C.

When the oil phase is added wax or the aqueous gel is at a second stage cross-linking condition, the resulting gel composition does not melt entirely but renders like a solid animal adipose tissue. Solid remains, but some liquid will gradually come out. The melting point is around 180-200° C.

When the oil phase is added wax and the aqueous gel is at a second stage cross-linking condition, the resulting gel composition does not melt entirely but renders like a solid animal adipose tissue. Solid remains, but some liquid will gradually come out. The melting point is around 180-250° C.

The results are summarized in Table 4:

TABLE 4

| | Melting Point | |
|---|---|---|
| Conditions | (° C.) | Note |
| Oil phase without wax | 100-110 | Melts like coconut oil |
| and | | |
| Aqueous gel at first stage | | |
| cross-linking condition | | |
| Oil phase with wax | 170-200 | Does not melt entirely |
| or | | Renders like a solid animal |
| Aqueous gel at second | | adipose tissue |
| stage cross-linking | | |
| condition | | |
| Oil phase with wax | 200-250 | Does not melt entirely |
| and | | Renders like a solid animal |
| Aqueous gel at second | | adipose tissue |
| stage cross-linking | | |
| condition | | |

This example illustrates that the cross-linking conditions have an impact on the properties of the gel composition.

### Example 6

Several food products containing the gel composition or edible composition as a fat substitute are prepared. The gel composition or edible composition may be incorporated into food products by any appropriate method available to those skilled in the art. For example, the gel composition of the present disclosure may be marbled into alternative bacon as shown in FIG. 4A. The photographs of these food products containing the gel composition 10 are respectively shown 10 in FIG. 4A (plant-based bacon), 4B (plant-based fried burger patties), 4C (plant-based meatball), and 4D (plant-based pepperoni).

What is claimed is:

1. A gel composition comprising:
an oleogel dispersed within an aqueous gel which is continuous phase;
wherein the oleogel comprises either a plant-based oil in liquid state at room temperature and a wax, or a plant-based oil in non-liquid state at room temperature; and
wherein the aqueous gel comprises water and at least one of protein and polysaccharide.

2. The gel composition according to claim 1, wherein the plant-based oil is approximately 50-85 weight percent of the gel composition and the aqueous gel is approximately 15-50 weight percent of the gel composition.

3. The gel composition according to claim 1, wherein the wax is approximately 0.1-5 weight percent of the oleogel.

4. The gel composition according to claim 1, wherein the wax is selected from a group consisting of bee's wax, candelilla wax, Carnuba wax, rice bran wax, paraffin wax, sugarcane wax, sunflower wax, jojoba wax, ouricury wax, Myrica fruit wax, berry wax, microcrystalline wax, Japan wax, and retamo wax.

5. The gel composition according to claim 1, wherein the plant-based oil in liquid state at room temperature is selected from a group consisting of coconut oil, canola oil, sunflower oil, grapeseed oil, avocado oil, palm oil, olive oil, vegetable oil, algal oil, corn oil, high oleic oil, almond oil, cottonseed oil, Macadamia oil, peanut oil, soybean oil, walnut oil, sesame oil, safflower oil, flaxseed oil, rapeseed oil, rice bran oil, hemp oil, castor oil, and pecan oil.

6. The gel composition according to claim 1, wherein the plant-based oil in non-liquid state at room temperature is selected from a group consisting of coconut oil, palm oil, and cocoa butter.

7. The gel composition according to claim 1, wherein the protein is approximately 0.01-20 weight percent of the aqueous gel.

8. The gel composition according to claim 1, wherein the protein in the aqueous gel is cross-linked.

9. The gel composition according to claim 1, wherein the protein is selected from a group consisting of soy protein isolate, pea protein isolate, soy protein concentrate, gluten flour, wheat protein, potato protein, pea protein concentrate, whey protein isolate/concentrate, fava bean protein, chickpea protein, lentil protein, gelatin, and collagen.

10. The gel composition according to claim 1, wherein a pH of the aqueous gel is approximately between 3 to 8.

11. The gel composition according to claim 1, wherein the polysaccharide in the aqueous gel is cross-linked.

12. The gel composition according to claim 1, wherein the polysaccharide is selected from a group consisting of carrageenan, chondroitin sulfate, gum Arabic, guar gum, konjac gum, pectin, plant fibers, alginate, agar, gellan gum, locust bean gum, xanthan gum, curdlan gum, methylcellulose, tara gum, carboxymethyl cellulose, and bacteria cellulose.

13. The gel composition according to claim 1, wherein a hardness of the gel composition ranges approximately from 30 to 250 gf measured by Texture Profile Analysis using a trigger force of 1 g, a target distance of 3 mm, and a test speed of 2 mm/s.

14. The gel composition according to claim 1, wherein the oleogel does not comprise a hydrogenated oil.

15. The gel composition according to claim 1, wherein the gel composition has a melting point above approximately 80° C.

16. The gel composition according to claim 1, wherein the gel composition has a melting point above approximately 180° C.

17. An edible composition comprising a gel composition according to claim 1.

18. The edible composition according to claim 17, wherein the edible composition is an animal fat substitute.

19. The edible composition according to claim 17, further comprising a flavorant.

20. A food product comprising an edible composition according to claim 17.

21. The food product according to claim 20, wherein the food product is selected from a group consisting of a vegan product, a vegetarian product, an animal-free product, an alternative-meat product, a plant-based product, or a free of animal-derived product.

22. A method of manufacturing a gel composition, comprising:
providing an oleogel at a temperature above approximately 70° C., wherein the oleogel comprises a plant-based oil in non-liquid state at room temperature or is prepared by mixing a plant-based oil in liquid state at room temperature and a wax;
providing an aqueous gel at a first stage cross-linking condition by mixing water and at least one of protein and polysaccharide; and
forming the gel composition by dispersing the oleogel in the aqueous gel which is continuous phase.

23. The method of claim 22, wherein the plant-based oil is approximately 50-85 weight percent of the gel composition and the aqueous gel is approximately 15-50 weight percent of the gel composition.

24. The method of claim 22, wherein the first stage cross-linking condition is produced by applying heat to above approximately 70° C., applying high-intensity sonication, adding enzyme, or changing a pH of the aqueous gel.

25. The method of claim 22, wherein the aqueous gel in the gel composition is at a second stage cross-linking condition which is stronger than the first stage cross-linking condition.

26. The method of claim 25, wherein the second stage cross-linking condition is produced by adding enzyme or ionic compound to the gel composition.

27. A method of manufacturing a food product comprising a step of incorporating the gel composition of claim 1 into the food product.
